(19) United States
(12) Patent Application Publication
(10) Pub. No.: US 2012/0064219 A1
(43) Pub. Date: Mar. 15, 2012

(54) EXTRUDED PARTICLES

(75) Inventors: Jérôme Barra, Neydens (FR); Pierre-Etienne Bouquerand, Pers-Jussy (FR); Dana Zampieri, Landecy (CH)

(73) Assignee: Firmenich SA, Geneva (CH)

(21) Appl. No.: 13/319,939

(22) PCT Filed: Jun. 8, 2010
(86) PCT No.: PCT/IB2010/052528

§ 371 Date: Nov. 10, 2011

(30) Foreign Application Priority Data
Jun. 8, 2009 (EP) 09162137.5

(51) Int. Cl. A23L 1/236; A23P 1/02

(52) U.S. Cl. 426/548

(57) ABSTRACT

An extruded particle for use in a foodstuff, such as chewing gum, the extruded particle including a carrier matrix of ethyl cellulose and a hydrophobic plasticizer, and a sweetening component having a clogP of from -0.5 to 1.0 dispersed throughout the matrix. The extruded particle prolongs or sustains the perception of a flavor during chewing or consumption of the foodstuff.

### TECHNICAL FIELD

The present invention relates to extruded particles comprising an encapsulated sweetening component. It also relates to a foodstuff, beverage, oral care or pharmaceutical product comprising such extruded particles.

### BACKGROUND AND PRIOR ART

Much effort has been directed to prolonging flavour release and perception in food products and particularly in chewing gum compositions. Activity in this area has focused on modifying the flavour composition with increased emphasis on longer lasting base or middle notes, increasing the quantity of flavour present or providing the flavour in an encapsulated form.

It is also known to encapsulate sweeteners in chewing gum applications to provide longer lasting sweetness.

For instance, U.S. Pat. No. 4,597,970 discloses a chewing gum composition comprising a gum base; an agglomerated sweetener delivery system capable of effecting a controlled release of core material comprising at least one natural or artificial core material selected from the group consisting of amino acid based sweeteners, dipeptide sweeteners, glycyrrhizin, saccharin and its salts, acesulfame salts, cyclamates, steviosides, talin, dihydrochalcone compounds, flavouring agents and mixtures thereof; a hydrophobic matrix consisting essentially of lecithin and an edible material having a melting point in the range of about 25° C. to about 100° C. selected from the group consisting of (a) fatty acids having an iodine value of about 1 to about 10, (b) natural waxes, (c) synthetic waxes and (d) mixtures thereof; and at least one glyceride.

WO-A-84/00320 discloses a food-grade shellac encapsulant for active chewing gum ingredients. Encapsulation of sweetener, flavouring agent, food grade acid and pharmaceutical agents to achieve a gradual and controlled release of such ingredients is described. The ratio of shellac to sweetener such as aspartame is about 1:20 to about 0.9:1.

U.S. Pat. No. 4,911,934 discloses a chewing gum composition containing a sweetening agent encapsulated in a coating material comprising a hydrophobic polymer, such as a cellulose ether, and a hydrophobic plasticizer. Encapsulation is preferably performed by forming a wet mix of the ingredients and then oven drying to form granules. The encapsulated sweetening agent is said to give sustained release of sweetener.

US-A-2004/0180068 refers to cellulose-based particles and liquids as well as methods for their preparation. The particles comprise flavour as a plasticizer and a non-polar active ingredient.

US-A-2005/0220867 discloses a delivery system for active component as part of an edible composition having a preselected tensile strength. Edible compositions include chewing gum and the active component may be a high intensity sweetener.

None of these documents refer to the use of an encapsulated sweetening agent to enhance the longevity and intensity of flavour perception.

In addressing the abovementioned issues, it is further desirable to avoid encapsulation systems which require additional solvents. Thus, for instance, spray-coating should be avoided.

Furthermore, sweetening ingredients that are either too hydrophobic or too hydrophilic are less desirable. In particular, when the sweetener is highly hydrophilic, it will be released too quickly in a chewing gum and so will not provide the desired flavour release profile. This is a known problem for sweetening agents such as acesulfame-K. For instance, document DE-A1-3120857 discloses the use of acesulfame-K in chewing gum and describes the sensory properties as rapid, perceptible and clear sweetness. WO-A1-96/20608 also refers to the release characteristics of acesulfame-K and discloses a method to control the release of acesulfame-K in chewing gum by coating and drying. However, this entraps the sweetener in the gum base, and so the sweetener remains entrapped as long as the integrity of the carrier is maintained.

Similarly, when the sweetener is very hydrophobic, it will be released very slowly in a chewing gum. This is known characteristic of neohesperidin dihydrochalcone. The time/intensity profile of neohesperidin dihydrochalcone is characterized by a delayed onset and long duration of sweetness perception (Marie-Odile Portmann and David Kilcast, Food Chemistry Volume 56, Issue 3, July 1996, Pages 291-302; G. A Crosby et al in: Developments in Sweeteners, C. A. M Hough et al (Ed), 1, 135-164. Applied Science Publishers Ltd, London, 1979; G. E. Dubois et al: Journal of Agricultural and Food Chemistry 1981 29 1269-1276).

Furthermore, when such a sweetener is entrapped into a hydrophobic carrier, it will remain in the gum base as long as the integrity of the carrier is maintained, and, upon chewing, the sweetener at the surface of the hydrophobic carrier interacts with the gum, thus delaying release in the mouth. The sweetener within the swelling front of the gum base will be released even more slowly as it will interact with the matrix system. Consequently, when such a sweetener is used, there is no beneficial effect when using an encapsulated system.

The present invention seeks to address one or more of the abovementioned problems and/or to provide one or more of the abovementioned benefits.

### SUMMARY OF THE INVENTION

Accordingly, the present invention provides an extruded particle for use in a foodstuff, beverage, oral care or pharmaceutical product, the extruded particle comprising a carrier matrix, the matrix comprising ethyl cellulose and a hydrophobic plasticizer, and a sweetening component having a clogP of from −0.5 to 1.0 dispersed throughout the matrix.

For the purposes of the present invention, ClogP is measured using the commercially available program, EPI Suite™ V3, 2000 as provided by the US Environmental Protection Agency.

In another aspect, the invention provides a foodstuff, beverage, oral care or pharmaceutical product comprising the abovementioned extruded particle.

In a further aspect, the invention provides the use of the extruded particle to prolong or sustain the perception of a flavour during chewing or consumption of a foodstuff, beverage, oral care or pharmaceutical product.

In yet another aspect the invention provides a method of preparing extruded particles comprising the steps of extruding a mixture comprising ethyl cellulose, a hydrophobic plasticizer and the sweetening component and granulating the extruded material to form particles.

### DETAILED DESCRIPTION OF THE INVENTION

The present invention relates to extruded particles for use in a foodstuff, the extruded particles comprising a carrier matrix for the sweetening agent.

Matrix Component

The matrix component or carrier for the sweetening component comprises ethyl cellulose and a hydrophobic plasticizer. More preferably, the carrier consists essentially of ethyl cellulose and a hydrophobic plasticizer.

It is especially important that the matrix comprises these components since this provides the desired release profile of the sweetening component and thus enables the longer-lasting flavor or sweetness perception that is desired. Such a release profile is not typically seen with conventional matrices used in extrusion, such as those based primarily on maltodextrin having a DE of between 5 and 20.

Ethyl cellulose is a derivative of cellulose in which a certain number of the hydroxyl groups on the repeating glucose backbone are converted into ethyl groups. The number of groups converted is also referred to as the degree of substitution.

In the context of the present invention, the degree of substitution per glucose repeat unit is preferably from 2 to 3, more preferably from 2.22 to 2.81. At this degree of substitution, it is found that the ethyl cellulose provides a very stable matrix.

It is preferred that the viscosity of the ethyl cellulose is from 50 mPa.s to 1′000 mPa.s, more preferably 75 mPa.s to 750 mPa.s, most preferably 100 mPa.s to 500 mPa.s, measured as a 5% solution based on 80% toluene 20% ethanol, at 25° C. in an Ubbelohde viscometer.

The molecular weight of the cellulose ether derivative is preferably within the range of from 50′000 to 2′000′000, more preferably from 75′000 to 1′500′000, most preferably from 100′000 to 1′250′000.

Commercially available ethyl cellulose suitable for use in the present invention includes, for instance, the Klucel® range, ex Aqualon-Hercules.

The ethyl cellulose may be used in combination with compatible carriers. However, it should preferably not be used in combination with other cellulose derivatives. For instance, hydroxypropyl cellulose cannot readily be plasticized with hydrophobic plasticizers, such as oils or terpenes, and is unacceptable for use in the extruded product of the present invention.

The amount of ethyl cellulose is preferably from 95 to 40% by weight, based on the total weight of the extruded particle, more preferably 80 to 40%, most preferably 75 to 50%.

Hydrophobic Plasticizer

A further essential component of the matrix is an effective amount of a plasticizer for the ethyl cellulose. The plasticizer facilitates the extrusion process which, in its absence, would be exceptionally difficult or even impossible.

The plasticizer is hydrophobic. Hydrophilic plasticizers are unacceptable for use in the present invention as they do not facilitate the extrusion process with the ethyl cellulose matrix and do not afford an extruded particle having the desired soft texture.

By hydrophobic it is meant that the plasticizer preferably has a clogP of 1 or more, more preferably 2 or more, most preferably 3 or more.

Preferably the plasticizer is liquid at 25° C. since this also enables the formation of particles which are compatible with foodstuffs where the desired texture is soft or chewable.

Preferably the plasticizer is substantially tasteless since it is desirable to avoid interfering with the sweet taste generated by the stevia component.

A preferred class of plasticizers are fatty acids, more preferably linear or branched fatty acids having a carbon chain length of from C₁₂ to C₂₂, more preferably C₁₄ to C₂₀ fatty acids, most preferably C₁₆ to C₁₈. Surprisingly, triglycerides do not plasticize the matrix effectively and so are preferably excluded as plasticizers in the context of the present invention.

The effective amount of plasticizer depends on the molecular weight of the ethyl cellulose. Nevertheless, the effective amount is readily and easily ascertained by the person skilled in the art of extrusion through routine work not involving undue burden or experimentation.

As an example though, it is preferred that the weight ratio of plasticizer to ethyl cellulose is from 1:48 to 1:2.

For instance, the amount of plasticizer is preferably from about 2 to 20% by weight, based on the total weight of the extruded particle.

Sweetening Component

The extruded particle according to the invention further comprises a sweetening component having a clogP of from −0.5 to 1.0, more preferably from −0.5 to 0.5, most preferably from −0.5 to 0.2. Below a clogP of −0.5, it is found that the sweetening component.

Suitable sweetening components typically include one of a stevia component such as stevioside or rebaudioside A, sodium cyclamate, aspartame, sucralose and sodium saccharine, or mixtures thereof. All the aforementioned sweeteners are commercially available. Of these sweetening agents, a stevia component is the most preferred.

In the context of the present invention, the phrase “Stevia Component” denotes a material that consists of, includes or is derived from the stevia plant. Thus, the Stevia component can be taken to mean the Stevia plant itself, any sweet part thereof, extracts thereof, stevia derivatives, such as steviol glycosides and mixtures thereof.

Stevia or Stevia rebaudiana Bertoni is a sweet-tasting plant. The leaves contain a complex mixture of natural sweet diterpene glycosides. Steviol glycosides, e.g., steviosides and rebaudiosides, are components of Stevia that contribute sweetness. Typically, these compounds are found to include stevioside (4-13% dry weight), steviolbioside (trace), the rebaudiosides, including rebaudioside A (2-4%), rebaudioside B (trace), rebaudioside C (1-2%), rebaudioside D (trace), and rebaudioside E (trace), and dulcoside A (0.4-0.7%). The following nonsweet constituents also have been identified in the leaves of stevia plants: labdane, diterpene, triterpenes, sterols, flavonoids, volatile oil constituents, pigments, gums and inorganic matter.

Suitable stevia derivatives include stevia-based sweetening systems containing a high level of rebaudioside A, a main component contributing to the sweetness of stevia. Thus, it is preferred that the stevia component is a stevia derivative comprising more than 30%, more preferably more than 60%, even more preferably more than 85%, most preferably more than 90%, e.g. more than 95% rebaudioside A by weight based on the total weight of stevia component.

Other suitable stevia derivatives include stevia-based systems comprising a high level of stevioside.

Alternatively, a suitable stevia derivative may comprise both stevioside and rebaudioside A at various ratios.

The sweetening component is preferably present in an amount of from 3 to 40%, more preferably from 5 to 20%, most preferably from 10 to 15% by weight, based on the total weight of the extruded particle.

Surprisingly, it has been found that the beneficial effect of longer lasting flavour or sweetness due to the specific encapsulation system is not achieved when the system comprises a sweetening agent such as neohesperidin dihydrochalcone, which has a clogP of 1.8, or Acesulfame K, which has a clogP of −0.6. In particular, it is found that the release mechanism from a chewing gum base of these sweeteners is not beneficially altered. Thus, the extruded particle of the present invention is preferably substantially free of such sweeteners.

Other ingredients, compounds or compositions may be present in the extruded system. For instance, perfumes, flavours, flavour enhancers, sensate compounds, nutritional ingredients, colours and preservatives are given by way of non-limiting examples.

It is not essential that a flavour is encapsulated to achieve the benefit of longer lasting flavour perception. That is, the flavour can be provided separately from the extruded particle and yet a consumer can still perceive the benefit of prolonged or sustained flavour release.

The extruded particles are formed by a process comprising the steps of extruding a mixture comprising ethyl cellulose, a hydrophobic plasticizer and the sweetening component and granulating the extruded material to form particles.

In a first preferred aspect, the process comprises the steps of:
(i) preparing a substantially homogeneous mixture of ethyl cellulose with the sweetening component, the mixture either being prepared within the extruder or prepared prior to being added into the extruder and then added therein,
(ii) introducing an effective amount of a hydrophobic plasticizer into the mixture in the extruder,
(iii) extruding the mixture at a temperature at which the mixture is molten and (iv) granulating the extruded material to form particles.

In a second preferred aspect, the process comprises the steps of:
(i) preparing a mixture of ethyl cellulose with an effective amount of a plasticizer, the mixture either being prepared within the extruder or prepared prior to being added into the extruder and then added therein,
(ii) introducing the sweetening component into the mixture in the extruder,
(iii) extruding the mixture at a temperature at which the mixture is molten and
(iv) granulating the extruded material to form particles.

The advantage of this second process is that it reduces the degree of exposure of the sweetening component, which may be sensitive to heat, to the high temperatures present in the extruder.

Surprisingly, various other methods of producing capsules are not suitable for use with the matrix ingredients used in the present invention. Notably, spray-drying is not compatible since ethyl cellulose is a highly viscous biopolymer which cannot be broken easily into the small droplets that are necessary for the atomization step of spray-drying. Thus, a very large amount of plasticizer would be required and this would create additional difficulties and complications. Furthermore, if it was attempted to use oleic acid as the plasticizer in a spray-drying process, it would not vaporize and a liquid rather than a powder or granule would result.

The extruded particles are preferably incorporated into a foodstuff in order to prolong the perception of flavour or sweetness during consumption or chewing of the foodstuff.

The foodstuff may be any foodstuff where flavour or sweetness intensity is desired to be maintained for a prolonged duration. For instance, the foodstuff may be a chewable product which is kept in the mouth for several minutes. Examples include but are not limited to chewing gums, bubble gum, chewing sticks, chewing pellets and the like. In the context of the present invention, the term “chewing gum” denotes all of the aforementioned chewable products.

Chewing gums, their ingredients and methods of manufacture are well known. For instance, suitable gum bases for use with the extruded particles may be any water-insoluble gum base well known in the art. Illustrative examples of suitable polymers in gum bases include without limitation substances of vegetable origin such as chicle, jelutong, guttapercha and crown gum; synthetic elastomers such as butadiene-styrene copolymer, isobutylene isoprene copolymer, polyethylene, polyisobutylene and polyvinylacetate and the like.

The amount of gum base can vary depending on factors such as the type of base used, consistency desired and other components used to make the final product. Typically, from about 5% to about 45% by weight of gum base based on the total weight of the foodstuff is preferred, more preferably 15% to 30% by weight.

The chewing gum may contain additional conventional additives, including fillers such as calcium carbonate and talc; emulsifiers such as glyceryl monostearate and lecithin; coloring agents such as titanium dioxide and other conventional chewing gum additives known to the person skilled in the art.

The chewing gum composition of the present invention can also include additional other non-encapsulated sweeteners if desired to deliver an instant, but short-lasting, sweetness.

Flavours that can be used in chewing gums include synthetic solid flavouring agents and/or liquids derived from plants, leaves, flowers, fruits and so forth and combinations thereof. Representative flavouring liquids include: spearmint oil, cinnamon oil, oil of wintergreen (methylsalicylate), peppermint oils, natural or synthetic fruit flavours such as citrus oil, including lemon, orange, grape, lime and grapefruit, fruit essences including apple, strawberry, cherry and pineapple can be used.

The amount of flavouring agent employed is normally a matter of preference subject to factors such as flavour type, base type and strength. In general, amounts of 0.5% to about 3% by weight are used in chewing gum compositions with preferred amounts being from about 0.3% to about 1.5%, the most preferred ranges being from 0.7 to about 1.4%.

The encapsulated sweetening component can be added to conventional chewing gum compositions in an amount from about 0.2% to about 8% by weight of the final chewing gum composition, more preferably from about 0.5% to about 5%, most preferably from about 1% to about 3% by weight.

The chewing gum may also comprise a water-soluble bulking agent. For instance, the bulking agent may consist of dextrose, maltose, dextrin, lactose, galactose, polydextrose, sorbitol, mannitol, xylitol or combinations thereof. Such bulking agents are present in an amount ranging from about 30% to about 80% by weight of the entire chewing gum composition.

The chewing gum can be manufactured in any conventional manner, the following merely being an example.

Firstly, the base is heated from about 70° C. to about 120° C. and placed into a mixer. If coloring is desired, it may be added at this point, followed by the bulking agent, if any, the encapsulated sweetening agent or agents, the gum plasticizing agent and the flavouring agent. When the chewing gum is removed from the mixer, the mixture is rolled or extruded, cut into individual pieces, cooled and then wrapped in a known manner.

### EXAMPLES

The invention will now be described with reference to the following examples. It is to be understood that the examples are illustrative of the invention and that the scope of the invention is not limited thereto.

Samples according to the invention are denoted by a number and comparative examples by a letter. All amounts are % by weight unless otherwise indicated.

### Example 1

Preparation of Encapsulated Sweeteners

An encapsulated stevia sweetener was prepared comprising the following ingredients in the amounts shown (grams).

TABLE 1

| Ingredient | Amount (grams) |
|---|---|
| Sweetener Component (1) | 105 |
| Ethyl cellulose N7 (2) | 700 |
| Tocopherol, Vitamin E (3) | 2 |
| Oleic acid (4) | 193 |

(1) Stevia Rebaudioside A content of 97%, ex Blue California, USA
(2) ex Aqualon/Hercules
(3) ex RCA, Germany
(4) ex Biodroga, Canada

The sweetener component was mixed with the ethyl cellulose powder until homogeneous. The powdery mixture was then introduced at a rate of 820 g/hour into an extruder (PRISM 16 mm, Thermo Electron, Germany). Simultaneously, the oleic acid was injected at a rate of 178 g/hour into the barrel of the extruder through a side port using a gear pump. The screw speed was set at about 350 rpm. The temperature of the last two barrels and the die were held at 98° C. and 95° C. respectively. The die-plate aperture diameter was 1 mm

As the molten extrudate exited the die, it was chopped into discrete particles having an approximate size of 1.5 mm using a cutter-knife located at the die-face.

This sweetening system is referred to as “Stevia—example 1”.

### Example 2

Preparation of Comparative Encapsulated Sweeteners—Acesulfame K

The methodology according to example 1 was followed to prepare an encapsulated Acesulfame K sweetening system except that the sweetener was present at 120 g and the oleic acid at 178 g. This system is referred to as “Acesulfame K—example 2”.

### Example 3

Preparation of Encapsulated Sweeteners—Aspartame

The methodology according to example 1 was followed to prepare an encapsulated

Aspartame sweetening system except that the sweetener was present at 81.7 g and the oleic acid at 216.3 g. This system is referred to as “Aspartame—example 3”.

### Example 4

Preparation of Encapsulated Sweeteners—Sucralose

The methodology according to example 1 was followed to prepare an encapsulated Sucralose sweetening system except that the sucralose was present at 99 g and the oleic acid at 199 g. This system is referred to as “Sucralose—example 4”.

### Example 5

Preparation of Encapsulated Sweeteners—Sodium Saccharine

The methodology according to example 1 was followed to prepare an encapsulated sodium saccharine sweetening system except that sodium saccharin was present at 120 g and oleic acid at 178 g. This system is referred to as “saccharine—example 5”.

### Example 6

Preparation of Comparative Encapsulated Sweeteners—Neohesperidin Dihydrochalcone

The methodology according to example 1 was followed to prepare an encapsulated neohesperidin dihydrochalcone sweetening system except that NHDC was present at 50 g and the oleic acid at 228 g. This system is referred to as “NHDC—example 6”.

Unless otherwise stated, the sweeteners used in the examples were purchased from Sigma-Aldrich.

### Example 7

Preparation of Flavoured Chewing Gums

An unflavoured chewing gum was prepared having the following ingredients in the amounts shown.

TABLE 2

| Ingredient | Amount (wt %) |
|---|---|
| Solsona T Gum Base (1) | 12.46 |
| Vega Gum Base (1) | 12.46 |
| Crystalline sorbitol P60W | 60.8 |
| Maltitol Syrup | 10.3 |
| Glycerin | 3.98 |

(1) ex Cafosa

To prepare the chewing gum base, a Sigma-blade mixer was pre-heated to 45° C.-50° C. and half of the polyols were added. The gum base was pre-heated to 60° C-65° C. and added to the mixer. Mixing was carried out for approximately 4 minutes. The remaining polyols and humectants were added and mixing was continued for a further 4 minutes.

The unflavoured chewing gum prepared above was then flavoured and sweetened to provide the chewing gum compositions shown in the following two tables:

TABLE 3

| Component | Sample A | Sample 1 | Sample B | Sample 2 | Sample C | Sample 3 |
|---|---|---|---|---|---|---|
| Unflavoured Chewing Gum | 96.06 | 96.06 | 95.47 | 95.72 | 94.49 | 94.74 |
| Strawberry Flavour (1) | 1.2 | 1.2 | 1.2 | 1.2 | 1.2 | 1.2 |
| Citric acid | 1.0 | 1.0 | 1.0 | 1.0 | 1.0 | 1.0 |
| Stevia (97%) - | 0.2 | — | — | — | — | — |
| unencapsulated | | | | | | |
| Stevia - example 1 | — | 1.90 | — | — | — | — |
| Acesulfame K - | — | — | 0.25 | — | — | — |
| unencapsulated | | | | | | |
| Acesulfame K - example 2 | — | — | — | 2.08 | — | — |
| Aspartame - unencapsulated | — | — | — | — | 0.25 | — |
| Aspartame - example 3 | — | — | | | — | 3.06 |
| Empty capsule (2) | 1.90 | — | 2.08 | — | 3.06 | — |

(1) ex Firmenich, Geneva, Switzerland (reference 744621 02T)
(2) Flexarome ®, ex Firmenich, Switzerland ref: LAB2594FBS. An extruded particle comprising the same matrix ingredients as examples 1 to 3 but without sweetener encapsulated therein.

TABLE 4

| Component | Sample D | Sample 4 | Sample E | Sample 5 | Sample F | Sample 6 |
|---|---|---|---|---|---|---|
| Unflavoured Chewing Gum | 96.79 | 96.69 | 95.47 | 95.72 | | |
| Strawberry Flavour (1) | 1.2 | 1.2 | 1.2 | 1.2 | 1.2 | 1.2 |
| Citric acid | 1.0 | 1.0 | 1.0 | 1.0 | 1.0 | 1.0 |
| Sucralose - unencapsulated | 0.1 | — | — | — | — | — |
| Sucralose - example 4 | — | 1.01 | — | — | — | — |
| Saccharin - unencapsulated | — | — | 0.20 | — | — | — |
| Saccharin - example 5 | — | — | — | 1.67 | — | — |
| NHDC - unencapsulated | — | — | — | — | 0.04 | — |
| NHDC - example 6 | — | — | | | — | 0.80 |
| Empty capsule (2) | 1.01 | — | 1.67 | — | 0.80 | — |

(1) ex Firmenich, Geneva, Switzerland (reference 744621 02T)
(2) Flexarome ®, ex Firmenich, Switzerland ref: LAB2594FBS. An extruded particle comprising the same matrix ingredients as examples 4 to 6 but without sweetener encapsulated therein.

To prepare each sample, the unencapsulated sweetener was added to the unflavoured chewing gum preparation and mixed for approximately 2 minutes. The flavour was then added and mixing continued for 2 to 4 minutes. Finally, the encapsulated sweetener (or empty capsule) was added and mixing continued for a further 2 minutes. The sweetened chewing gum was discharged, laminated and cut into sticks or slabs.

Thus, the paired samples (i.e. sample A is paired with sample 1, sample B is paired with sample 2 and so on) had iso-loading of the sweetening agent in the chewing gum.

### Example 8

Sensory Analysis of Chewing Gums Sweetened with Sweetening Component

18 trained panelists assessed each chewing gum sample for flavour and sweetness intensities at four time intervals: 5, 10, 20 and 30 minutes. Samples were presented blind and following a balanced presentation order. The flavour intensity and sweetness intensity were each evaluated on a scale of 0 to 10 where 0 denotes no flavour or sweetness and 10 denotes very strong flavour or sweetness.

The analysis was performed for each of the paired samples, as indicated below.

### Example 8a

The mean scores for flavour intensity and sweetness intensity for samples A and 1 are given in the following tables.

Test

| | Sample A | Sample 1 |
|---|---|---|
| Flavour Intensity (time) | Mean | Mean |
| 5 minutes | 4.43 | 4.65 |
| 10 minutes | 2.74 | 3.59 |
| 20 minutes | 1.68 | 2.01 |
| 30 minutes | 1.12 | 1.3 |

Test

| | Sample A | Sample 1 |
|---|---|---|
| Sweetness Intensity (time) | Mean | Mean |
| 5 minutes | 4.15 | 4.75 |
| 10 minutes | 3.54 | 4.43 |
| 20 minutes | 2.62 | 3.5 |
| 30 minutes | 2.14 | 2.67 |

### Example 8b

The mean scores for flavour intensity and sweetness intensity for samples B and 2 are given in the following tables.

Test

| | Sample B | Sample 2 |
|---|---|---|
| Flavour Intensity (time) | Mean | Mean |
| 5 minutes | 4.26 | 4.72 |
| 10 minutes | 2.63 | 3.1 |
| 20 minutes | 1.5 | 1.9 |
| 30 minutes | 0.93 | 1.15 |

Test

| | Sample B | Sample 2 |
|---|---|---|
| Sweetness Intensity (time) | Mean | Mean |
| 5 minutes | 4.43 | 4.58 |
| 10 minutes | 2.58 | 3.03 |
| 20 minutes | 1.44 | 1.92 |
| 30 minutes | 1.02 | 1.33 |

### Example 8c

The mean scores for flavour intensity and sweetness intensity for samples C and 3 are given in the following tables.

Test

| | Sample C | Sample 3 |
|---|---|---|
| Flavour Intensity (time) | Mean | Mean |
| 5 minutes | 3.92 | 4.40 |
| 10 minutes | 2.58 | 2.97 |
| 20 minutes | 1.71 | 2.01 |
| 30 minutes | 1.14 | 1.45 |

Test

| | Sample C | Sample 3 |
|---|---|---|
| Sweetness Intensity (time) | Mean | Mean |
| 5 minutes | 4.72 | 4.43 |
| 10 minutes | 3.56 | 3.43 |
| 20 minutes | 2.73 | 2.64 |
| 30 minutes | 2.07 | 1.95 |

### Example 8d

The mean scores for flavour intensity and sweetness intensity for samples D and 4 are given in the following tables.

Test

| | Sample D | Sample 4 |
|---|---|---|
| Flavour Intensity (time) | Mean | Mean |
| 5 minutes | 4.67 | 4.66 |
| 10 minutes | 2.88 | 3.36 |
| 20 minutes | 1.68 | 2.09 |
| 30 minutes | 0.98 | 1.57 |

Test

| | Sample D | Sample 4 |
|---|---|---|
| Sweetness Intensity (time) | Mean | Mean |
| 5 minutes | 4.88 | 4.34 |
| 10 minutes | 3.53 | 3.48 |
| 20 minutes | 2.45 | 2.51 |
| 30 minutes | 1.62 | 1.99 |

### Example 8e

The mean scores for flavour intensity and sweetness intensity for samples E and 5 are given in the following tables.

Test

| | Sample E | Sample 5 |
|---|---|---|
| Flavour Intensity (time) | Mean | Mean |
| 5 minutes | 3.55 | 4.83 |
| 10 minutes | 2.2 | 3.25 |
| 20 minutes | 1.35 | 2.14 |
| 30 minutes | 0.84 | 1.46 |

Test

| | Sample E | Sample 5 |
|---|---|---|
| Sweetness Intensity (time) | Mean | Mean |
| 5 minutes | 3.83 | 4.93 |
| 10 minutes | 2.58 | 3.65 |
| 20 minutes | 1.78 | 2.92 |
| 30 minutes | 1.21 | 2.03 |

### Example 8f

The mean scores for flavour intensity and sweetness intensity for samples F and 6 are given in the following tables.

Test

| | Sample F | Sample 6 |
|---|---|---|
| Flavour Intensity (time) | Mean | Mean |
| 5 minutes | 3.59 | 3.75 |
| 10 minutes | 2.47 | 2.34 |
| 20 minutes | 1.71 | 1.6 |
| 30 minutes | 1.19 | 1.32 |

Test

| | Sample F | Sample 6 |
|---|---|---|
| Sweetness Intensity (time) | Mean | Mean |
| 5 minutes | 4.27 | 3.9 |
| 10 minutes | 2.9 | 2.84 |
| 20 minutes | 1.97 | 2.04 |
| 30 minutes | 1.77 | 1.83 |

### Example 9

LC-MS Analysis of Chewing Gum Samples

3 panelists were given various samples of chewing gum prepared above and instructed to chew the gums for 60 minutes. At various intervals, a saliva sample was taken from each panelist, diluted 50 times in water and then analysed by standard LC-MS to confirm the amount of sweetening component remaining in the mouth. The results are as follows:

### Example 9a

### Sucralose

| Sample E | Conc. In saliva [μg/g] | | |
|---|---|---|---|
| Time [min] | Subject 1 | Subject 2 | Subject 3 |
| 0.0 | n.d. | — | n.d. |
| 1.0 | 52.8 | — | 133.5 |
| 2.0 | 27.8 | — | 97.7 |
| 3.0 | 24.9 | — | 60.7 |
| 5.0 | 21.1 | — | 31.0 |
| 10.0 | 15.2 | — | 19.6 |
| 15.0 | 11.0 | — | 17.8 |
| 20.0 | 6.3 | — | 13.8 |
| 30.0 | n.d. | — | 7.9 |
| 40.0 | n.d. | — | 5.9 |
| 60.0 | n.d. | | n.d. |

| Sample 5 | Conc. In saliva [μg/g] | | |
|---|---|---|---|
| Time [min] | Subject 1 | Subject 2 | Subject 3 |
| 0.0 | n.d. | n.d. | n.d. |
| 1.0 | 11.7 | n.d. | 12.1 |
| 2.0 | 23.9 | 5.0 | 22.3 |
| 3.0 | 35.2 | 6.9 | 26.7 |
| 5.0 | 61.6 | 13.1 | 36.0 |
| 10.0 | 59.7 | 19.9 | 29.0 |
| 15.0 | 65.1 | 28.8 | 27.1 |
| 20.0 | 63.0 | 36.1 | 38.6 |
| 30.0 | 38.6 | 23.4 | 28.1 |
| 40.0 | 12.8 | 18.3 | 17.8 |
| 60.0 | n.d. | 9.7 | 11.8 |

The results demonstrate that, in the unencapsulated form, the amount of sucralose diminishes rapidly almost immediately whereas, when encapsulated, it increase during the initial 5 to 10 minutes and then remains remarkably stable for at least until 20 minutes have elapsed.

### Example 9b

### Acesulfame K

| Sample B | Conc. In saliva [μg/g] | | |
|---|---|---|---|
| Time [min] | Subject 1 | Subject 2 | Subject 3 |
| 0.0 | n.d. | n.d. | n.d. |
| 1.0 | 295.3 | 212.7 | 228.5 |
| 2.0 | 169.9 | 143.8 | 203.4 |
| 3.0 | 141.6 | 115.2 | 171.0 |
| 5.0 | 79.1 | 61.3 | 99.3 |
| 10.0 | 43.6 | 34.4 | 93.0 |
| 15.0 | 43.3 | 15.6 | 47.6 |
| 20.0 | 28.5 | 6.1 | 29.9 |
| 30.0 | 4.4 | 2.1 | 9.1 |
| 40.0 | 1.2 | n.d. | 3.7 |
| 60.0 | n.d. | n.d. | n.d. |

| Sample 2 | Conc. In saliva [μg/g] | | |
|---|---|---|---|
| Time [min] | Subject 1 | Subject 2 | Subject 3 |
| 0.0 | n.d. | n.d. | n.d. |
| 1.0 | 215.8 | 82.5 | 364.6 |
| 2.0 | 241.4 | 154.7 | 501.6 |
| 3.0 | 287.5 | 165.0 | 449.5 |
| 5.0 | 290.8 | 134.1 | 391.6 |
| 10.0 | 133.0 | 77.6 | 227.1 |
| 15.0 | 95.8 | 72.4 | 224.7 |
| 20.0 | 32.6 | 48.7 | 140.4 |
| 30.0 | 6.5 | 23.8 | 40.7 |
| 40.0 | 3.2 | 5.5 | 12.2 |
| 60.0 | 0.7 | 0.5 | 4.7 |

The results demonstrate that the encapsulation of Acesulfame K has little effect of the release profile of the sweetener compared to the unencapsulated form.

### Example 9c

### Aspartame

| Sample C | Conc. In saliva [μg/g] | | |
|---|---|---|---|
| Time [min] | Subject 1 | Subject 2 | Subject 3 |
| 0.0 | n.d. | n.d. | n.d. |
| 1.0 | 22.5 | 2.2 | 77.6 |
| 2.0 | 7.6 | 1.3 | 40.7 |
| 3.0 | 12.2 | 1.9 | 36.8 |
| 5.0 | 14.8 | 4.1 | 71.6 |
| 10.0 | 13.6 | 6.5 | 61.9 |
| 15.0 | 2.0 | 5.0 | 69.1 |
| 20.0 | 0.4 | 5.6 | 21.7 |
| 30.0 | n.d. | 2.1 | 12.0 |
| 40.0 | n.d. | 1.9 | 0.6 |
| 60.0 | n.d. | 1.1 | n.d. |

| Sample 3 | Conc. In saliva [μg/g] | | |
|---|---|---|---|
| Time [min] | Subject 1 | Subject 2 | Subject 3 |
| 0.0 | n.d. | n.d. | n.d. |
| 1.0 | 2.7 | 1.6 | 14.4 |
| 2.0 | 4.0 | 4.2 | 29.0 |
| 3.0 | 5.4 | 3.9 | 30.9 |
| 5.0 | 5.3 | 3.3 | 114.5 |
| 10.0 | 9.3 | 5.2 | 216.2 |
| 15.0 | 93.4 | 4.6 | 132.5 |
| 20.0 | 15.8 | 8.3 | 158.0 |
| 30.0 | 11.9 | 7.7 | 138.5 |
| 40.0 | 4.5 | 2.4 | 51.4 |
| 60.0 | 0.8 | 2.1 | 16.8 |

The results demonstrate that, after 15 minutes, the difference in release profile between unencapsulated and encapsulated form of aspartame becomes significant with the encapsulated form releasing at a surprisingly stable rate for up to 40 minutes.

1. An extruded particle for use in a foodstuff, the extruded particle comprising a carrier matrix, the matrix comprising ethyl cellulose and a hydrophobic plasticizer, and a sweetening component having a clogP of from −0.5 to 1.0 dispersed throughout the matrix.

2. An extruded particle according to claim 1, wherein the sweetening component has a clogP of from −0.5 to 0.5.

3. An extruded particle according to claim 1, wherein the sweetening component has a clogP of from −0.5 to 0.2.

4. An extruded particle according to claim 1, wherein the sweetening component is selected from the group consisting of a stevia component such as stevioside or rebaudioside A, sodium cyclamate, aspartame, sucralose and sodium saccharine, or mixtures thereof.

5. An extruded particle according to claim 1, wherein the ethyl cellulose is present in an amount of from 95 to 40% by weight, based on the total weight of the extruded particle.

6. An extruded particle according to claim 1 wherein the hydrophobic plasticizer is a C₁₆ to C₁₈ fatty acid.

7. An extruded particle according to claim 1, wherein the weight ratio of hydrophobic plasticizer to ethyl cellulose is from 1:48 to 1:2.

8. An extruded particle according to claim 1, wherein the sweetening component is present in an amount of from 3 to 40%, by weight, based on the total weight of the extruded particle.

9. A foodstuff comprising an extruded particle for use in a foodstuff, the extruded particle comprising a carrier matrix, the matrix comprising ethyl cellulose and a hydrophobic plasticizer, and a sweetening component having a clogP of from −0.5 to 1.0 dispersed throughout the matrix.

10. (canceled)

11. A method of preparing extruded particles comprising the steps of extruding a mixture comprising ethyl cellulose, a hydrophobic plasticizer and a sweetening component having a clogP of from −0.5 to 1.0 and granulating the extruded material to form particles.

12. A method according to claim 11 comprising the steps of:
(i) preparing a substantially homogeneous mixture of ethyl cellulose with a sweetening component having a clogP of from −0.5 to 1.0, the mixture either being prepared within the extruder or prepared prior to being added into the extruder and then added therein,
(ii) introducing a plasticizing quantity of oleic acid into the mixture in the extruder,
(iii) extruding the mixture at a temperature at which the mixture is molten and
(iv) granulating the extruded material to form particles.

13. A method according to claim 11 comprising the steps of:
(i) preparing a mixture of ethyl cellulose with a plasticizing quantity of oleic acid, the mixture either being prepared within the extruder or prepared prior to being added into the extruder and then added therein,
(ii) introducing a sweetening component having a clogP of from −0.5 to 1.0 into the mixture in the extruder,
(iii) extruding the mixture at a temperature at which the mixture is molten and
(iv) granulating the extruded material to form particles.

14. A method for prolonging or sustaining the perception of a flavour during chewing or consumption of a foodstuff comprising adding to such foodstuff an extruded particle comprising a carrier matrix, the matrix comprising ethyl cellulose and a hydrophobic plasticizer, and a sweetening component having a clogP of from −0.5 to 1.0 dispersed throughout the matrix.
